(19) United States
(12) Patent Application Publication
(10) Pub. No.: US 2007/0058783 A1
(43) Pub. Date: Mar. 15, 2007

(54) Load computer programmed to simulate a thermal load of an x-ray device

(76) Inventor: Johannes Ebersberger, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/516,289

(22) Filed: Sep. 5, 2006

(30) Foreign Application Priority Data
Sep. 5, 2005 (DE) 10 2005 042 088.5

(51) Int. Cl. H05G 1/28; H05G 1/00; F25D 23/12

(52) U.S. Cl. 378/162; 378/210; 165/267

(57) ABSTRACT

A load computer with a program simulates the thermal load of an x-ray device having anodes, wherein an i-th fluid is provided for cooling the i-th anode and a first cooling fluid is provided for cooling the i-th fluids. The program simulates a first cooling temperature of the first cooling fluid, such that the thermal load is accurately simulated.

### BACKGROUND OF THE INVENTION

1. Field of the Invention

The present invention concerns a load computer with a program for implementation of a method for simulation of a thermal load of an x-ray device and x-ray device.

2. Description of the Prior Art

In x-ray devices, in particular tomography apparatuses, a load computer is typically used to monitor the thermal load of the x-ray tube. Such a load computer is known, for example, from DE 198 11 041. A spatiotemporal temperature distribution of the anode struck by electrons can be calculated with a method implemented by the known load computer. One disadvantage of this method is that the method for calculation of the temperature distribution requires a high computational outlay. In particular, operation of the load computer in real time is not possible. The method can also not be simply transferred to different x-ray tubes and anode types. The method must be adapted to properties of the x-ray tube and to the physical condition of the respective anode. The method implemented with the load computer is time-consuming and costly.

In other methods for calculating the thermal load of the x-ray tube, an average power supplied to the anode of the x-ray tube in a time interval with fixed length is limited to a load (power) limit. Upon exceeding the load limit the operation of the x-ray tube is interrupted to protect against a thermal overload. A disadvantage of the method is that no temperature of the x-ray device (such as, for example, the anode temperature) is taken into account. It can occur that the load limit is exceeded without the temperature reaching or exceeding a predetermined limit temperature. This can lead to unnecessary interruptions and wait times. The capability (efficiency) of the x-ray tube cannot be fully utilized.

According to DE 10 2004 005 937 A1, a load computer monitors and limits the power absorbed (accepted) by an anode by a method in which the heat radiation and heat dissipation of the anode are taken into account. The heat can be dissipated in a coolant. The time-dependent temperature of the anode is calculated by solving a differential equation. Further temperature curves for monitoring of the heat budget of the cooling system are not calculated.

A method and a device for measuring the cooling capacity of a cooler of an x-ray tube are known from JP 2002214053 A. For determination of the temperature of a coolant housed in a tank, the cooler is connected with the tank at the input and output side.

### SUMMARY OF THE INVENTION

An object of the invention is to provide a load computer and a method implemented thereby that avoid the disadvantages according to the prior art. In particular a load computer with a program for implementation of a particularly simple and precise method for simulation of a thermal load of an x-ray detector should be provided. A load computer should also be specified with which a particularly high utilization of the x-ray device can be achieved. It is a further object of the invention to provide an x-ray device with a load computer with which the thermal load can be simulated particularly quickly and precisely so a particularly high tube utilization can be achieved.

This object is achieved in accordance with the invention by a load computer with a program for implementation of a method for simulation of a thermal load of an x-ray device with i anodes is, wherein i=1, 2, 3, . . . , wherein an i-th fluid is provided for cooling the i-th anode, a first cooling fluid is provided for cooling the first through i-th fluid and a second cooling fluid is provided for cooling the first cooling fluid. The load computer includes a temperature monitoring unit that monitors a first temperature and/or an i-th temperature, a sensor for determination of a first cooling temperature, and an i-th temperature sensor for determination of the i-th temperature. Using a solution function solving the following linear differential equation system, the program for implementation of the method predictively calculates the first cooling temperature of the first cooling fluid reflecting the thermal load in a time interval:
\dot{T}_{Fi}=1_{Pi}·Pᵢ=k₁ᵢ·(T_{Fi}−T_{KF1}) (1)
\dot{T}_{KF1}=Σᵢk₂ᵢ·(T_{Fi}−T_{KF1})−k₃·(T_{KF1}−T_{KF2})+I_{P0}·P₀ (2)
wherein P₀, Pᵢ, I_{Pi}, I_{P0}, k₁ᵢ, k₂ᵢ and k₃ are constant in the time interval. It follows from a physical plausibility consideration that the first cooling temperature is a constant function of the time. As a result, it is necessary that the solution function is constant at junctions of successive time intervals. In the differential equation system (1), (2),
\dot{T}_{Fi} represents the temporal change of the i-th temperature of the i-th fluid,
\dot{T}_{KF1,2} represents the temporal change of the first or second cooling temperature,
Pᵢ represents the i-th power radiated onto the i-th anode,
P₀ represents the loss power generated by an electrical consumer of the x-ray device,
I_{Pi} represents the power absorption coefficient of the i-th fluid for the power Pᵢ,
I_{P0} represents the power absorption coefficient of the first cooling fluid for the power P₀ and
k₁ᵢ, k₂ᵢ, and k₃ are temperature transition coefficients.

The thermal load of an x-ray device can be simulated particularly quickly and reliably with the load computer described herein. A particularly safe and disruption-free operation with a particularly high utilization of the x-ray device can be achieved.

For simplification, in the following indices of the first through i-th anodes, fluids, temperatures or powers are sometimes omitted. Insofar as it is not otherwise mentioned, the following statements concerning the terms “anode”, “fluid”, “temperature” or “power”0 correspondingly apply for one, a subset or all of the first through i-th anodes, fluids, temperatures or powers.

The x-ray device can have one or more anodes. The anodes can be identical or different types such as, for example, fixed anodes, rotating anodes, rotating envelope tubes or floating bearing tubes.

A fluid is provided for cooling for each anode. The fluid can be a gaseous or liquid coolant such as, for example, silicon oil, water or a liquid metal.

Heat is generated in the anode by radiation of the power. The anode is thermally coupled with the fluid. The heat is transferred to the fluid via the coupling. A change of the temperature of the fluid caused by the radiated power is described by the first term of the differential equation (1). The power absorption coefficient of the anode specifies which differential change of the temperature the power radiated onto the anode causes in the fluid.

The first cooling fluid is provided to cool the aforementioned fluid. The first cooling fluid is thermally coupled with the fluid. Heat is transferred to the first cooling fluid dependent on the difference of the temperature of the fluid and the first cooling temperature. A differential change of the temperature of the fluid thereby caused is described by the second term of the differential equation (1).

Each fluid coupled to the first cooling fluid can cause a differential change of the first cooling temperature, which is described by the sum term of the differential equation (2).

A second cooling fluid is provided to cool the first cooling fluid. A change of the temperature of the first cooling temperature caused by the second cooling fluid is described by the second term of the differential equation (2).

The first cooling fluid can be thermally coupled to other heat sources of the x-ray device. The other heat source can be one or more electrical consumers, for example an x-ray generator, a rotation motor of a rotating envelope x-ray tube, a control electronic and the like which generates/generate a loss power in the form of heat. The heat source causes a change of the first cooling temperature described by the third term in the differential equation (2).

The efficacy of the thermal coupling of the fluid to the first cooling fluid, of the first cooling fluid to the second cooling fluid and of the first cooling fluid to the heat source is respectively described by the temperature transition or, respectively, power absorption coefficients designated with k₁ᵢ and k₂ᵢ, k₃ and I_{P0}.

Different causes of the thermal load such as, for example, anodes and electrical consumers can be taken into account with the differential equation system (1), (2). The thermal load can be particularly precisely described and simulated using a solution function of the first cooling temperature. A particularly high utilization of the x-ray device can be achieved.

The differential equation system (1), (2) is a linear differential equation system. It can be solved with conventional mathematical methods. The solution function of the first cooling temperature can be composed of exponential terms and constant terms. Function values of such a solution function can be calculated particularly simply and quickly. The method enables a particularly simple and fast simulation of the thermal load.

In an embodiment of the invention, i=2. In this case the x-ray device comprises two anodes. The solution function of the first cooling temperature for the differential equation system (1), (2) for a point in time (t+δt) situated in the time interval [t; t+Δt] reads:
T_{KF1}(t+δt)={Σⱼ[Aⱼ·Bⱼ·exp(Bⱼ·δt)]−I_{P1}·P₁}/k₁₁+T_{F1}(t+δt). (3)
Solution functions for the first fluid and the second fluid are provided by:
T_{F1}(t+δt)=Σⱼ[Aⱼ·exp(Bⱼ·δt)]+S, (4)
T_{F2}(t+δt)={Σⱼ[Aⱼ·Bⱼ·(Bⱼ·k₁₁)·exp(Bⱼ·δt)]/k₁₁−k₂₁·T_{F11}(t+δt)+(k₂₁+k₂₂+k₃)·T_{F2}(t+δt)−k₃·T_{KF2}−I_{P0}·P₀}/k₂₂ (5)
The following applies for the solution functions (3)-(5):

$$j = 1 , 2 , 3$$

$${I}_{P 1} = {I}_{P 2} and$$

$$S = [ {I}_{P 1} \cdot ( {k}_{12} \cdot ( {k}_{21} + {k}_{3} ) \cdot {P}_{1} + {k}_{11} + {k}_{22} \cdot {P}_{2} ) + {k}_{11} \cdot {k}_{12} \cdot ( {k}_{3} \cdot {T}_{KF 2} + {I}_{P 0} \cdot {P}_{0} ) ] / {k}_{11} \cdot {k}_{12} \cdot {k}_{3} .$$

The Aⱼ are coefficients and the Bⱼ are zeros of the polynomial a₁·X³+a₂·X²+a₃·X⁴, with:

a₁=1,

a₂=k₁₁+k₁₂+k₂₁+k₂₂+k₃,

a₃=k₁₁·(k₁₂+k₂₂+k₃)+k₁₂·(k₂₁+k₃),

a₄=k₁₁·k₁₂·k₃ and

a₅=I_{P1}·[k₁₂·(k₂₁+k₃)·P₁+k₁₁·k₂₂·P₂]+k₁₁·k₁₂·(k₃·T_{KF2}+I_{P0}·P₀).

The second cooling temperature T_{KF2} can be assumed to be constant. The aforementioned conditions for S, Bⱼ, a₁ through a₅ as well as the polynomial and the coefficients Aⱼ result by solving the differential equation system (1), (2) for i=2.

The solution functions (3) through (5) apply in the time interval [t; t+Δt] in which the quantities P₀, P₁, P₂, I_{P1}, I_{P2}, I_{P0}, k₁₁, k₁₂, k₂₁, k₂₂ and k₃ are constant. Given a change of one of the quantities a new time interval begins subsequent to the time interval. Solution functions for the new time interval can be calculated with the aforementioned conditions for S, a₁ through a₅, Aⱼ and Bⱼ. It follows from physical plausibility considerations that a constant transition of the solution functions for the first and second temperature and the first cooling temperature ensues at a junction of the new time interval with the time interval. Constant junction conditions can be described with a simple equation system. For example, in matrix notation the equation system reads:

$$( \begin{matrix}1 & 1 & 1 \\ {B}_{1} & {B}_{2} & {B}_{3} \\ {B}_{12} & {B}_{22} & {B}_{32}\end{matrix} ) \cdot ( \begin{matrix}{A}_{1} \\ {A}_{2} \\ {A}_{3}\end{matrix} ) = ( \begin{matrix}{C}_{1} \\ {C}_{2} \\ {C}_{3}\end{matrix} ) \qquad ( 6 )$$

wherein
C₁=T_{F1}(t+δt)−S
C₂=k₁₁·[(T_{KF1}(t+δt)−T_{F1}(t+δt)]+I_{P1}·P₁

$${C}_{3} = {k}_{11} \cdot \{ ( {k}_{11} + {k}_{21} ) \cdot [ {T}_{F 1} ( t + δ t ) - {T}_{KF 1} ( t + δ t ) ] + {k}_{22} \cdot [ ( {T}_{F 2} ( t + δ t ) ) - ( {T}_{KF 1} ( t + δ t ) ] - {k}_{3} \cdot [ {T}_{F 1} ( t + δ t ) - {T}_{KF 2} ( t + δ t ) ] - {I}_{P 1} \cdot {P}_{1} + {I}_{P 0} \cdot {P}_{0} \}$$

Function values of the solution functions (3) through (5) can be calculated with simple calculation operations. The calculation operations can be executed on a load computer. The method specified for i=2 enables a fast and precise simulation of the thermal load of the x-ray device with two anodes. The thermal load can be simulated particularly comprehensively. A particularly high utilization of the x-ray device can be achieved based on the simulation.

In the embodiment, the maximum value of the first cooling temperature can be calculated and used as a quantity reflecting the thermal load. The maximum value can be calculated for a number of successive time intervals.

To calculate the maximum value, a function of the second order is adapted to temporally-successive first cooling temperatures and a maximum of the function is used as a maximum value. The maximum of the function of the second order (such as, for example, a parabola) can be determined in a simple manner, for example with known solution formulas. It is not necessary to calculate the maximum value of the solution function (which is possibly difficult to calculate) for one or more successive time interval(s). Three or six or more first cooling temperatures calculated for successive points in time can be used to determine the function of the second order. The outlay for calculation of the maximum value can be reduced by using the simple-to-operate function of the second order.

In another embodiment, the thermal load is simulated for an execution of a predetermined x-ray protocol. The i-th powers used in the simulation can be extracted from the predetermined x-ray protocol. Using the x-ray protocol it can also be determined for which time intervals the quantities P₀, P₁, I_{P1}, I_{P0}, k₁ᵢ, k₂ᵢ and k₃ are constant.

An upper limit value can be predetermined for the first cooling temperature. Given an overrun of the limit value an execution of the x-ray protocol can be prevented and/or a warning can be output. It is also possible to insert a first wait time into the first x-ray protocol so that the first cooling temperature does not exceed the limit value given an execution of the x-ray protocol. It can be avoided that x-ray protocols are executed which excessively thermally load the x-ray device. The simulation and the insertion of the wait time preferably are implemented before an execution of the x-ray protocol. A thermal overload and damage or function interruptions of the x-ray device can be reliably prevented by limitation of the first cooling temperature to the limit value.

The i-th temperature is calculated and used as a further quantity reflecting the thermal load. The i-th temperature reflects a thermal load of the i-th anode. The thermal load of individual anodes can be checked. An i-th limit temperature can be predetermined for the i-th temperature. Upon an overrun of the i-th limit temperature, the execution of the x-ray protocol can be prevented, a warning can be output and/or a second wait time can be determined and inserted into the x-ray protocol such that the i-th temperature does not exceed the i-th limit temperature given the execution of the x-ray protocol. A thermal overload of the i-th anode can be reliably avoided. A particularly safe and material-protective operation of the x-ray device can be ensured.

According to an embodiment of the invention, the i-th power is smaller than or equal to a predetermined i-th maximum power. The i-th maximum power can be provided in the form of a table or, respectively, matrix for a given anode or x-ray tube type dependent on x-ray current, focal size, rotation speed of a rotating envelope x-ray tube and the like. By an exchange of the table the method can be particularly simply adapted to differently-configured x-ray devices. The maximum powers can be predetermined such that the i-th anode can be loaded (charged) with the i-th maximum power without damage for at least 15 seconds, advantageously 20 seconds, particularly preferably 30 seconds. A particularly safer operation of the x-ray device can be ensured. The thermal load of the anode can be less given a shorter loading of the i-th anode. In this case the i-th maximum power can be increased by a factor between 1.05 and 1.15, preferably between 1.08 and 1.12. A short-term increase of the maximum power enables a particularly high utilization of the x-ray device to be achieved.

In a further embodiment of the invention, the first through i-th fluids are liquid and the first cooling fluid is gaseous. The original fluid can be a coolant oil, water, a liquid metal or the like.

The gaseous first cooling fluid advantageously flows through a housing of the x-ray device. In this manner electrical consumers (such as, for example, motors, electronic circuits etc.) located in the housing can be cooled in a simple manner with the first cooling fluid. The first cooling fluid can be circulated in the housing. A cooling of the circulating first cooling fluid can ensue with the second cooling fluid by means of a heat exchanger (likewise arranged in the housing). The housing can be a component of a gantry of an x-ray computed tomography apparatus.

The i-th anode and/or an x-ray tube housing surrounding the i-th anode is advantageously impinged upon by the i-th fluid. The fluid can flow through a cooling device arranged at the tube housing. For example, the fluid can flow around or through the x-ray tube housing. The fluid also can flow through the inside of the anode.

According to a further embodiment of the invention, the first cooling temperature and/or the i-th temperature is measured and a respective measurement value for a predetermined point in time is compared with the correspondingly-calculated cooling and/or i-th temperature and, given a deviation, the cooling and/or the i-th temperature is replaced by the corresponding measurement value. Conventional technical data of the cooling system, of the anodes and of the electrical consumers are used in the simulation. The data used in the simulation can be adapted to the actual present data of the x-ray device via a comparison. A calibration of the simulation can be implemented. The values of the first cooling temperature and/or of the i-th temperature at predetermined points in time also can be conformed to one another, for example given an initial initialization or after an operating pause of the x-ray device. A deviation of the simulated cooling temperature from the measured first cooling temperature can also indicate, for example, an overheating of an electronic component. As a result it is possible, using the deviation, to establish operation disruptions of the x-ray device such as, for example, disruptions of the cooling system, of the anodes and/or of the electrical consumers. A safer operation of the x-ray device can be achieved by the comparison of the measured cooling temperature with the simulated cooling temperature and/or the i-th temperature.

The time curve of the first cooling temperature and/or of the first through i-th temperature can be shown on a monitor. The measured first cooling temperature and the measured and/or calculated i-th temperature can also be shown on the monitor.

According to a further embodiment of the invention, the load computer can comprise a controller to control the x-ray device dependent on a thermal load simulated with the program.

According to a further requirement of the invention, an x-ray device is provided with the inventive load computer. The x-ray device can be an x-ray computed tomography apparatus. The x-ray device with load computer can be operated particularly safely and in a user-friendly manner. An optimal utilization of the x-ray device can also be achieved.

### DESCRIPTION OF THE DRAWINGS

FIG. 1 is a schematic model of heat flow in the x-ray device that forms the basis of the inventive method.

FIG. 2 is a first temperature-time diagram of a simulation in accordance with the invention.

FIG. 3 is a second temperature-time diagram to illustrate the calculation of a maximum value of the first cooling temperature in accordance with the invention.

FIG. 4 schematically shows a gantry of an x-ray computed tomography apparatus with a load computer operable in accordance with the invention.

FIG. 5 is a third temperature-time diagram comparing a simulation in accordance with the invention, with a conventional load monitoring method

### DESCRIPTION OF THE PREFERRED EMBODIMENTS

FIG. 1 shows a schematic model of a the flow in the x-ray device that forms the basis of the inventive method. A first anode A1 is loaded with a first power P1. A second anode A2 is loaded with a second power P2. A first fluid F1 is provided to cool the first anode A1 and a second fluid F2 is provided to cool the second anode A2. A first cooling fluid KF1 is provided to cool the first fluid F1 and second fluid F2. A loss power generated by a consumer is designated with P0. To cool the consumer this is thermally coupled with the first cooling fluid KF1. A second cooling fluid KF2 is provided to cool the first cooling fluid KF1. A first heat flow (caused by the first power (P1) from the first anode A1 to the first fluid F1 is designated with reference character W1. A second heat flow (caused by the second power P2) from the second anode A2 to the second fluid F2 is designated with the reference character W2. Third and fourth heat flows from the first fluid F1 and second fluid F2 to the first cooling fluid KF1 are respectively designated with the reference characters W21 and W22. A fifth heat flow from the first cooling fluid KF1 to the second cooling fluid KF2 is designated W3. A first temperature of the first fluid is designated with TF1 and a second temperature of the second fluid F2 is designated with TF2. A first cooling temperature of the first cooling fluid is designated with TKF1 and a second cooling temperature of the second cooling fluid is designated with TKF2.

The heat flow shown in FIG. 1 can be used as a basis for a simulation of the thermal load of the x-ray device. The first heat flow W1 leads to a change of the first temperature TF1 and the second heat flow W2 leads to a change of the second temperature TF2. The third heat flow and fourth heat flow W21 and W22 cause changes of the first cooling temperature TF1, the second cooling temperature TF2 an the first cooling temperature RKF1. The loss power P0 causes a change of the first temperature TKF1. The fifth heat flow W3 causes changes of the first cooling temperature TKF1 and of the second cooling temperature TKF2.

The changes of the first temperature TF1 and second temperature TF2 as well as of the first cooling temperature TKF1 can be described with the differential equations (1) and (2) for i=2. The solution functions (3) through (5) can be used in the simulation for calculation of a time curve of the first temperature TK1, the second temperature TF2 and the first cooling temperature TKF1. The first through fifth heat flows W1, W2, W21, W22 and W3 are described by the power absorption or, respectively, temperature transition coefficients I_{P1}, I_{P2}, k₁₁, k₁₂, k₂₁, k₂₂ and k₃. A temperature change of the first cooling temperature TKF1 that is caused by the loss power P0 is described by the power absorption coefficient I_{P0}.

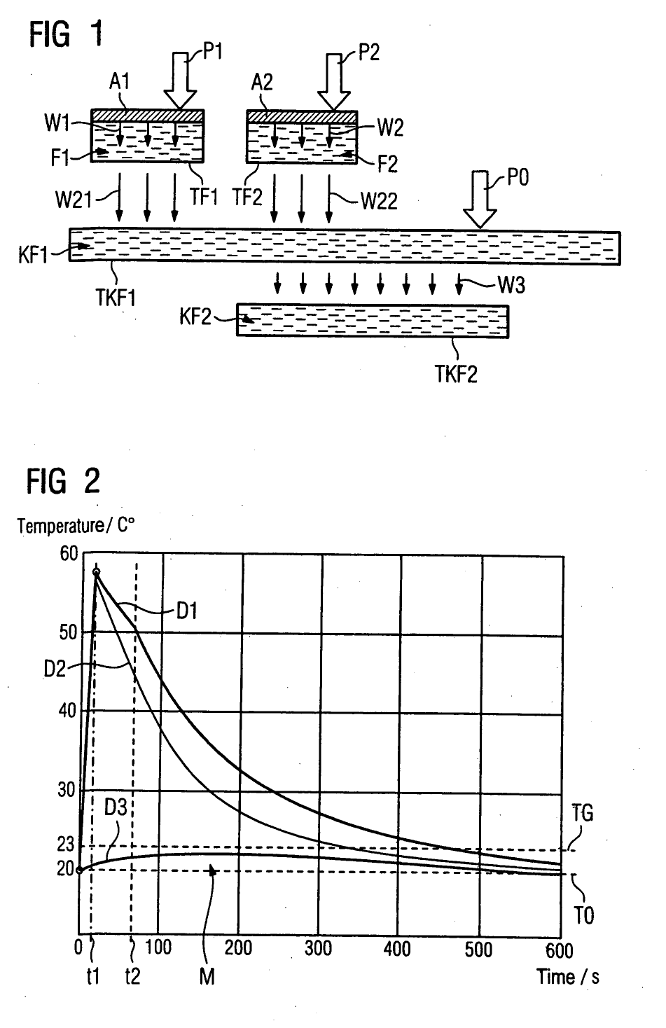

FIG. 2 shows a first temperature-time diagram of a simulation. The simulation is based on an x-ray device with two anodes. The time is plotted in seconds on the abscissa of the diagram and the temperature in ° C. is plotted on the ordinate. A first curve D1 representing the time curve of the first temperature TF1, a second curve D2 representing the time curve of the first temperature TF2 and a third curve D3 representing the time curve of the first cooling temperature TKF1 are shown in the first diagram. The reference character TG designates an upper limit value of the first cooling temperature TFK1. T0 designates an initial temperature for the first temperature TF1 and the second temperature TF2 as well as for the first cooling temperature TKF1. A first point in time and a second point in time are designated with the reference characters t1 and t2. The reference character M designates a maximum value for the first cooling temperature TKF1.

The simulation is based on the following assumptions: T0=20° C., TG=23° C., t1=12 s, t2=50 s. P1=P2=72 kW applies in a first time interval [0; 12 s]. P1=P2=0, P0=1 kW applies in a second time interval [12 s; 50 s] and P1=P2=P0=0 applies in a third time interval [50 s; 600 s]. P1 and P2 change at the first point in time t1 and P0 changes at the second point in time. The first through third time intervals are respectively described by a differential equation system of the form (1), (2), i=2. the first curve D1 is a continuous relationship of solution functions of the first temperature TF1 for the first through third time interval. The second curve D2 and third curve D3 are analogously continuous relationships of the solution functions for the second temperature TF1 and the first cooling temperature TKF1. The continuous junction conditions can, for example, be determined using the equation system (6) described above with (t+Δt)=t1, and t2. A better cooling was assumed for the second anode A2 than for the first anode A1. As a result of this the second curve D2 lies below the first curve D1.

A transfer of heat from the first anode A1 and second anode A2 to the first cooling fluid KF1 ensues with finite speed. As a result of this the temperature curve of the first cooling temperature TKF1 follows temporally offset relative to the temperature curve of the first temperature TF1 and second temperature TF2. The maximum value M is reached at the time t>t1, t2. Using the simulation it can be checked whether the first cooling temperature TKF1 or, respectively, the maximum value M exceeds the limit value TG. In the example shown in FIG. 2 the first cooling temperature TKF1 as well as the maximum value M stay below the limit value TG. An upper limit of the thermal load of the x-ray device is not exceeded. An x-ray protocol which fulfills the above assumptions can be executed without a thermal overload of the x-ray device.

As is apparent from FIG. 2, in addition to the first cooling temperature TKF1 the maximum value M can also be used as a quantity reflecting the thermal load of the x-ray device.

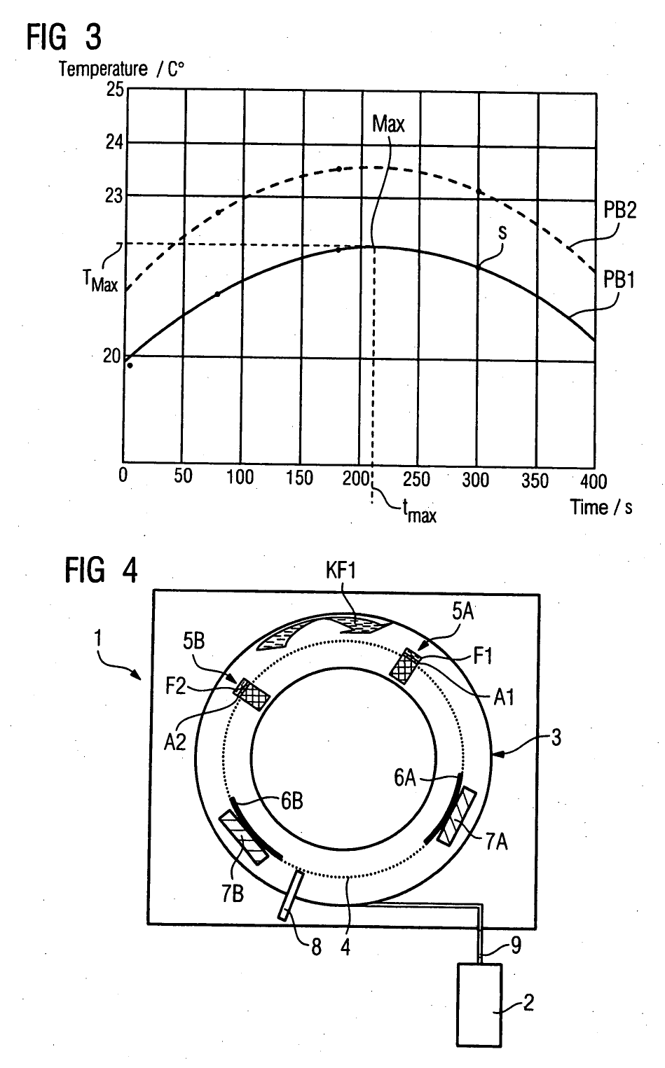

FIG. 3 shows a second temperature-time diagram to illustrate the calculation of the maximum value M of the first cooling temperature TKF1. The time is plotted in seconds on the abscissa of the second diagram and the temperature in ° C. is plotted on the ordinate. Points S filled in black designate simulated first cooling temperatures TKF1. A first parabola PB1 is adapted to the points S. Coordinates of a maximum Max are designated with tmax and Tmax. A second parabola is designated with PB2.

To calculate the maximum value M, the first parabola PB1 is adapted to the points S and the maximum Max=(tₘₐₓ, Tₘₐₓ) of the first parabola PB1 is used as a maximum value M of the first temperature TKF1. 3 to 6 or more points S can be simulated. The points S are advantageously simulated such that a point S respectively lies to the left and right of the maximum value M. That is the case for a temporally-successive series of points S1=(t1; T1), S2=(t2; T2), S3 (t3; T3), with t1<t2<t3 when it applies that: T1, T3<T2. With such calculated points S coefficients a, b, c of the first parabola PB1 of the general form ax²+bx+c can be determined in a known manner via a simple equation system. From the coefficients a, b and c the maximum Max of the first parabola PB1 can be determined at Max=b/2a; c−b²/4a).

In contrast to the first parabola PB1, the second parabola PB2 exceeds the limit value TG. Upon exceeding the limit value TG an execution of the x-ray protocol forming the basis of the simulation can be prevented or a warning can be generated or displayed.

In the case of an overrun it is also possible to calculate a wait time and to insert said wait time into the x-ray protocol such that the first cooling temperature TKF1 no longer exceeds the limit value TG given an execution of the x-ray protocol. The calculation of the wait time for an x-ray protocol can be implemented as follows: the value of the wait time is initially increased from a starting value in 50 s steps. For each value of the wait time the time curve of the first cooling temperature TKF1 is simulated and the associated maximum value M or, respectively, the maximum Max is calculated. The value of the wait time is increased until the maximum value M is for the first time equal to or smaller than the limit value TG. A third parabola PB3(t) is in turn adapted to the calculated maximum value M as a wait time function. A zero of PB3(t)−TG situated in the value range of the wait times indicates that wait time at which the limit value TG is not directly exceeded.

FIG. 4 schematically shows a gantry 1 of an x-ray computed tomography apparatus with a load computer 2. The gantry 1 has a first x-ray tube 5A and second x-ray tube 5B mounted on a rotatable frame 4 in a housing 3. The first x-ray tube 5A or, respectively, second x-ray tube 5B comprises a first anode A1 or, respectively, second anode A2. A first fluid F1 or, respectively, a second fluid F2 is provided to cool the first anode A1 or, respectively, second anode A2. A first detector 6A or, respectively, second detector 6B is arranged situated opposite the first x-ray tube 5A or, respectively, the second x-ray tube 5B on the frame 4. An electronic unit for control and/or image processing that is attached on the frame and connected with the first detector 6A or, respectively, with the second detector 6B is designated with the reference character 7A or, respectively, 7B. A first cooling fluid circulating in the housing 3 is designated with KF1. A heat exchanger 8 with a second cooling fluid (not shown) is provided for cooling of the first cooling fluid. The load computer 2 is connected with the gantry via a data or bus line 9 for data exchange or for transfer of control signals.

The function of the gantry 1 and of the load computer 2 is as follows:

In the operation of the first x-ray tube 5A and/or the second x-ray tube 5B, the first anode A1 and/or the second anode A2 are/is charged with a first and/or second power (not shown). The first x-ray tube 5A and/or the second x-ray tube 5B can be a fixed x-ray tube, rotating anode x-ray tube, rotating envelope x-ray tube or a slide bearing x-ray tube. Only one anode and one detector can also be mounted on the frame 4. Three or more anodes and detectors can also be mounted. They can be the same or different anode types. The anodes and detectors can be mounted on the frame 4 offset against one another by an angle between 0 and 180 degrees. The loading of the first anode A1 and/or of the second anode A2 leads to a temperature increase of the first anode A1 and/or second anode A2 and of the first fluid F1 and/or second fluid F2. Depending on the anode type the first anode A1 or the second anode A2 can interact with the first fluid F1 or the second fluid F2 on an underside or internally. For cooling, the first fluid F1 or the second fluid F2 can also flow around or through the x-ray housing of the first anode A1 or second anode A2. Given operation of the x-ray device drive motors of rotating anode and rotating envelope x-ray tubes, the first electronic unit 7A and second electronic unit 7B and electrical consumers (not shown) that are located in the housing 3 cause a thermal load. The first cooling fluid KF1 is circulated in the housing to reduce the thermal load. The heat absorbed by the first cooling fluid KF1 is discharged out from the housing 3 via the heat exchanger 8 by means of the second cooling fluid KF2.

The load computer 2 is provided for simulation of the thermal load. Before execution of an x-ray protocol the load computer 2 simulates (with a program provided for this) the first cooling temperature and/or the maximum value M in a temporally predictive manner. The simulation can ensue with the method describe with regard to FIG. 1 through 3.

Upon an overrun of the limit value of the first cooling temperature, the load computer can prevent an execution of the x-ray protocol or output a warning. The load computer 2 automatically calculates a first wait time and inserts this into the x-ray protocol such that the limit value is not exceeded given an execution of the x-ray protocol.

The load computer also simulates the respective temperatures of the first anode A1 and the second anode A2. Given an overrun of a limit temperature for the temperature, the load computer can prevent the execution of the x-ray protocol, output a warning or automatically calculate a second wait time and insert this into the x-ray protocol so that the limit temperature is not exceeded given an execution of the x-ray protocol.

To check the actual temperature with the simulated temperature or first cooling temperature, the load computer can comprise a temperature monitoring unit. The temperature of the first fluid F1 and/or second fluid F2 and/or the first cooling temperature of the first cooling fluid KF1 can be measured using temperature sensors (not shown). A calibration can be implemented with measured values. This is in particular advantageous at a startup of the x-ray computed tomography apparatus or after a longer operating pause. By a comparison of the simulated cooling temperature and the measured first cooling temperature it can also be established whether a malfunction exists in the cooling or in the components cooled by the first cooling fluid KF1. For example, given an overheating of an electronic component a greater quantity of heat would be emitted to the first cooling fluid KF1 than would be emitted based on the simulation. The simulated first cooling temperature would be measured smaller than the actual cooling temperature.

The time curve of the simulated and/or measured temperature, the first cooling temperature, warnings or the like can be displayed on a monitor (not shown) connected with the load computer.

To control functions of the x-ray computed tomography apparatus dependent on the result of the simulation, the load computer 2 can include a controller (not shown) connected with the gantry 1 via the data or bus line 9. The controller allows the load computer to automatically execute an x-ray examination after calculation of a suitable wait time for a predetermined x-ray protocol. An operation of the x-ray computed tomography apparatus can be simplified and an operation can be automated.

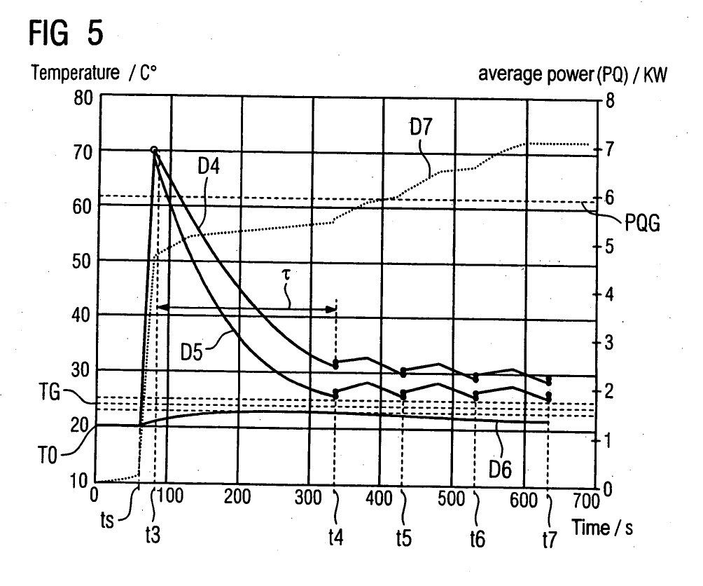

FIG. 5 shows a third temperature-time diagram. The time is plotted in seconds on the abscissa of the third diagram, the temperature is plotted in ° C. on the left ordinate and an average power PQ is plotted in kW on the right ordinate. The third diagram shows a comparison of a result of the inventive simulation with a conventional method for monitoring a thermal load of an x-ray device with two anodes. Shown in the third diagram are a fourth curve D4 reflecting the time curve of the first temperature of a first anode, a fifth curve D5 reflecting the time curve of the second temperature of a second anode and a sixth curve D6 reflecting the time curve of the first cooling temperature. A seventh curve D7 reflects a time curve of an average power PQ radiated onto the first or, respectively, second anode in a time interval of 10 minutes. The reference character TG designates an upper limit value of the first cooling temperature. T0 designates an initial temperature of the first temperature and second temperature and of the first cooling temperature. A start time is designated with tS and third through seventh points in time are designated with t3 through t7. A wait time is designated with the reference character τ. An average upper power limit is designated with PQG.

The simulation is based on the following assumptions: T0=20° C., TG=23° C., TFK2=12° C., P0=1 kW, t3−tS=20 s, P1=P2=60 kW in [TS; t3], P1=P2=0 in [t3; t4−0.5 s], P1=P2=10 kW in [t4−0.5 s; t4+0.5 s]. Analogous to t4, P1=P2=10 kW applies for the points in time t5 through t7.

A power of 60 kW is radiated onto both anodes in the time interval [tS; t3]. As a result of this the fourth curve D4 and fifth curve D5 rise. The wait time τ of 252 s follows the third point in time. After the wait time τ a power of 10 kW is radiated onto both anodes in the time interval [t4−0.5 s; t4+0.5 s]. The latter analogously applies for the fifth through seventh points in time t5 through t7. The wait time τ was determined based on the simulation of the first cooling temperature. The length of the wait time τ was calculated such that the sixth curve D6 of the first cooling temperature stays below the limit value TG. With the wait time τ so calculated an x-ray protocol based on the above assumptions can be implemented without an upper limit (provided by the limit value TG) of the thermal load of the x-ray device being exceeded.

By comparison, the average power PQ radiated onto each of the anodes in a time interval of 10 minutes is plotted relative to the time with the seventh curve D7. A limitation of the power radiated onto the anode in a fixed time interval of, for example, 10 minutes is a method known from the prior art for monitoring of the thermal load of an x-ray device. As can be learned from the curve of the seventh curve D7, the average power PQ has not yet reached the power limit PQG at the beginning of the determined wait time τ. The power limit PQG of the average power PQ is clearly exceeded for times with t>400 s. According to the known method this means that a further wait time would have to be inserted, while with the inventive method the limit value TG is not exceeded. From this comparison it is clear that the inventive method enables an improved utilization of the power.

With the inventive load computer with the program for implementation of the method it is possible to calculate the thermal load of the x-ray device particularly simply, precisely and comprehensively. A simulation of the thermal load with the inventive method also enables it to achieve a particularly high utilization of the x-ray device. The load computer can be used to control the x-ray device. An x-ray device with the load computer enables a particularly reliable operation and a particularly high utilization.

Although modifications and changes may be suggested by those skilled in the art, it is the intention of the inventor to embody within the patent warranted hereon all changes and modifications as reasonably and properly come within the scope of his contribution to the art.

I claim as my invention:

1. A load computer with a program for simulation of a thermal load of an x-ray device with i anodes, wherein i=1, 2, 3, . . . ; and wherein an i-th fluid is provided for cooling the i-th anode, a first cooling fluid is provided for cooling the first through i-th fluid and a second cooling fluid is provided for cooling the first cooling fluid the load computer comprising:
a temperature monitoring unit that monitors at least one of a first temperature or an i-th temperature;
a sensor for detecting a first cooling temperature;
an i-th temperature sensor for determination of an i-th temperature; and
said load computer is programmed to make a temporally predictive calculation of the first cooling temperature of the first cooling fluid reflecting the thermal load in a time interval using a solution function that solves the linear differential equation system:
\dot{T}_{Fi}=1_{Pi}=k₁ᵢ·(T_{Fi}−T_{KF1})
\dot{T}_{KF1}=Σᵢk₂ᵢ·(T_{Fi}−T_{KF1})−k₃·(T_{KF1}−T_{KF2})+I_{P0}·P₀;
wherein P₀, Pᵢ, I_{Pi}, I_{P0}, k₁ᵢ, k₂ᵢ and k₃ are constant in the time interval, and wherein the solution function is constant at junctions of successive time intervals, and wherein
\dot{T}_{Fi} is a temporal change of an i-th temperature of the i-th fluid,
\dot{T}_{KF1,2} is a temporal change of the first or, respectively, second cooling temperature,
Pᵢ is an i-th power radiated onto the i-th anode,
P₀ is a loss power generated by an electrical consumer of the x-ray device and transferred to the first cooling fluid,
I_{Pi} is a power absorption coefficient of the i-th fluid for the power Pᵢ,
I_{P0} is a power absorption coefficient of the first cooling fluid for the power P₀ and
k₁ᵢ, k₂ᵢ, and k₃ are temperature transition coefficients.

2. A load computer as claimed in claim 1, wherein i=2, the time interval is [t; t+Δt] and the solution function is:
T_{KF1}(t+δt)={Σⱼ[Aⱼ·Bⱼ·exp(Bⱼ·δt)]−I_{P1}·P₁}/k₁₁+T_{F1}(t+δt),
wherein
t+δδtε[t; t+Δt],
$${T}_{F 1} ( t + δ t ) = {Σ}_{j} [ {A}_{j} \cdot exp ( {B}_{j} \cdot δ t ) ] + S , \\ {T}_{F 2} ( t + δ t ) = \{ {Σ}_{j} [ {A}_{j} \cdot {B}_{j} \cdot ( {B}_{j} \cdot {k}_{11} ) \cdot exp ( {B}_{j} \cdot δ t ) ] / {k}_{11} - {k}_{21} \cdot {T}_{F 11} ( t + δ t ) + ( {k}_{21} + {k}_{22} + {k}_{3} ) \cdot {T}_{F 2} ( t + δ t ) - {k}_{3} \cdot {T}_{KF 2} - {I}_{P 0} \cdot {P}_{0} \} / {k}_{22} ,$$
j=1, 2, 3;
I_{P1}=I_{P2};
S=[I_{P1}·(k₁₂·(k₂₁+k₃)·P₁+k₁₁+k₁₁·k₂₂·P₂)+k₁₁·k₁₂·(k₃·T_{KF2}+I_{P0}·P₀)]/k₁₁·k₁₂·k₃
Aⱼ are coefficients, and
Bⱼ are zeros of the polynomial a₁·X³+a₂·X²+a₃·X⁴,
and wherein:
a₁=1,
a₂=k₁₁+k₁₂+k₂₁+k₂₂+k₃,
a₃=k₁₁·(k₁₂+k₂₂+k₃)+k₁₂·(k₂₁+k₃),
a₄=k₁₁·k₁₂·k₃ and
a₅=I_{P1}·[k₁₂·(k₂₁+k₃)·P₁+k₁₁·k₂₂·P₂]+k₁₁·k₁₂·(k₃·T_{KF2}+I_{P0}·P₀).

3. A load computer as claimed in claim 1 wherein said load computer is programmed to calculate maximum value of the first cooling temperature and for use as a quantity reflecting the thermal load.

4. A load computer as claimed in claim 3, wherein said computer is programmed to calculate the maximum value by adapting a function of the second order to temporally-successive first cooling temperatures and a maximum of the function of the second order is used as said maximum value.

5. A load computer as claimed in claim 1 programmed to simulate the thermal load for execution of a predetermined x-ray protocol by said x-ray device.

6. A load computer as claimed in claim 5 wherein an upper limit value of the first cooling temperature is predetermined, and wherein if an overrun of the limit value occurs in the simulation, execution of the x-ray protocol is prevented, and the load computer implements a preventive measure selected from the group consisting of emitting, a warning and inserting a first wait time into the x-ray protocol so that the first cooling temperature does not exceed the limit value in an actual execution of the x-ray protocol.

7. A load computer as claimed in claim 1 wherein the load computer is programmed to calculate the i-th temperature and use the i-th temperature as a further quantity reflecting the thermal load.

8. A load computer as claimed in claim 1 programmed to simulate the thermal load for execution of a predetermined x-ray protocol by said x-ray device and wherein an i-th limit temperature is predetermined for the i-th temperature and wherein, if an overrun of the i-th limit temperature occurs in the simulation, execution of the x-ray protocol is prevented and the load computer implements a preventive measure selected from the group consisting of emitting, a warning and determining a second wait time and inserting the wait time into the x-ray protocol so the i-th temperature does not exceed the i-th limit temperature in an actual execution of the x-ray protocol.

9. A load computer as claimed in claim 1 wherein the i-th power is less than or equal to a predetermined i-th maximum power.

10. A load computer as claimed in claim 9 wherein the i-th anode is loaded with the i-th maximum power without damage for at least 15 seconds, and wherein the load computer is programmed to simulate the i-th maximum power being increased by a factor between 1.05 and 1.15, when the i-th anode is loaded with the i-th power for less than 15 seconds.

11. A load computer as claimed in claim 1 wherein at least one of the first cooling temperature and the i-th temperature is measured to acquire a measurement value for a predetermined point in time and the load computer is programmed to compare the measurement value with the calculated cooling and/or i-th temperature, and wherein given a deviation, said at least one of the cooling and/or the i-th temperature is replaced by the measurement value.

12. A load computer as claimed in claim 1 comprising a monitor at which at least one of a time curve of the first cooling temperature and a time curve of the first through i-th temperature is shown.

13. An x-ray system comprising:
an x-ray device with i anodes, wherein i=1, 2, 3, . . . ; and wherein an i-th fluid is provided for cooling the i-th anode, a first cooling fluid is provided for cooling the first through i-th fluid and a second cooling fluid is provided for cooling the first cooling fluid;
a load computer comprising a temperature monitoring unit that monitors at least one of a first temperature or an i-th temperature, a sensor for detecting a first cooling temperature, an i-th temperature sensor for determination of an i-th temperature; and
said load computer is programmed to make a temporally predictive calculation of the first cooling temperature of the first cooling fluid reflecting the thermal load in a time interval using a solution function that solves the linear differential equation system:
\dot{T}_{Fi}=1_{Pi}·Pᵢ=k₁ᵢ·(T_{Fi}−T_{KF1})
\dot{T}_{KF1}=Σᵢk₂ᵢ·(T_{Fi}−T_{KF1})−k₃·(T_{KF1}−T_{KF2})+I_{P0}·P₀;
wherein P₀, P₁, I_{Pi}, I_{P0}, k₁ᵢ, k₂ᵢ and k₃ are constant in the time interval, and wherein the solution function is constant at junctions of successive time intervals, and wherein
\dot{T}_{Fi} is a temporal change of an i-th temperature of the i-th fluid,
\dot{T}_{KF1,2} is a temporal change of the first or, respectively, second cooling temperature,
Pᵢ is an i-th power radiated onto the i-th anode,
P₀ is a loss power generated by an electrical consumer of the x-ray device and transferred to the first cooling fluid,
I_{Pi} is a power absorption coefficient of the i-th fluid for the power Pᵢ,
I_{P0} is a power absorption coefficient of the first cooling fluid for the power P₀ and
k₁ᵢ, k₂ᵢ, and k₃ are temperature transition coefficients.

14. An x-ray system as claimed in claim 13 wherein the first through i-th fluid are liquid and the first cooling fluid is gaseous.

15. An x-ray system as claimed in claim 14 wherein the first cooling fluid flows through a housing of the x-ray device.

16. An x-ray system as claimed in claim 13, wherein the x-ray device is an x-ray computed tomography apparatus and the housing is a component of a gantry of the x-ray computed tomography apparatus.

17. An x-ray system as claimed in claim 16 wherein at least one of the i-th anode and an x-ray tube housing surrounding the i-th anode interacts with the i-th fluid.

18. An x-ray system as claimed in claim 13 comprising a controller that controls said x-ray device dependent on the thermal load simulated by the load computer.
